(19) United States
(12) Patent Application Publication
(10) Pub. No.: US 2013/0297318 A1
(43) Pub. Date: Nov. 7, 2013

(54) SPEECH RECOGNITION SYSTEMS AND METHODS

(71) Applicants: Shivakumar BALASUBRAMANYAM, San Diego, CA (US); Jeffrey D. BECKLEY, San Diego, CA (US); Pooja AGGARWAL, San Diego, CA (US)

(72) Inventors: Shivakumar BALASUBRAMANYAM, San Diego, CA (US); Jeffrey D. BECKLEY, San Diego, CA (US); Pooja AGGARWAL, San Diego, CA (US)

(73) Assignee: QUALCOMM INCORPORATED, San Diego, CA (US)

(21) Appl. No.: 13/462,638

(22) Filed: May 2, 2012

(51) Int. Cl. G10L 21/00

(52) U.S. Cl. CPC G10L 21/00
USPC 704/275

(57) ABSTRACT

A method of enabling speech commands in an application includes identifying, by a computer processor, a user interaction element within a resource of the application; extracting, by the computer processor, text associated with the identified user interaction element; generating, by the computer processor, a voice command corresponding to the extracted text; and adding the generated voice command to a grammar associated with the application.

### BACKGROUND

1. Field

This disclosure relates generally to speech recognition systems and methods. More particularly, the disclosure relates to systems and methods for enabling speech commands in an application.

2. Background

Speech recognition (SR) (also commonly referred to as voice recognition) represents one of the most important techniques to endow a machine with simulated intelligence to recognize user or user-voiced commands and to facilitate human interface with the machine. SR also represents a key technique for human speech understanding. Systems that employ techniques to recover a linguistic message from an acoustic speech signal are called voice recognizers. The term “speech recognizer” is used herein to mean generally any spoken-user-interface-enabled device or system.

The use of SR is becoming increasingly important for safety reasons. For example, SR may be used to replace the manual task of pushing buttons on a wireless telephone keypad. This is especially important when a user is initiating a telephone call while driving a car. When using a phone without SR, the driver must remove one hand from the steering wheel and look at the phone keypad while pushing the buttons to dial the call. These acts increase the likelihood of a car accident. A speech-enabled phone (i.e., a phone designed for speech recognition) would allow the driver to place telephone calls while continuously watching the road. In addition, a hands-free car-kit system would permit the driver to maintain both hands on the steering wheel during call initiation.

Electronic devices such as mobile phones may include speech-enabled applications. However, enabling an application for speech typically involves determining voice commands for each application context or screen manually and then adding the commands to a grammar that is compiled and used by a speech recognition system. Such a process for voice enabling legacy applications can be tedious and cumbersome.

### SUMMARY

A method of enabling speech commands in an application may include, but is not limited to any one or combination of: (i) identifying, by a computer processor, a user interaction element within a resource of the application; (ii) extracting, by the computer processor, text associated with the identified user interaction element; (iii) generating, by the computer processor, a voice command corresponding to the extracted text; and (iv) adding the generated voice command to a grammar associated with the application.

In various embodiments, the method further includes: detecting a speech input from a user; comparing the detected speech input to the grammar associated with the application; and performing an action if the detected speech input matches the grammar. The action corresponds to a generated voice command of the grammar matching the detected speech input.

In various embodiments, the resource of the application includes one or more of layout files, xml files, and objects for the application.

In various embodiments, the user interaction element includes at least one of a menu item, button, key, and operator.

In various embodiments, the computer processor is for executing the application.

In various embodiments, the application is stored on a client device for execution thereon by a computer processor of the client device.

In various embodiments, the method further includes transmitting the resource of the application a remote electronic device. The identifying includes identifying, by a computer processor of the remote electronic device, a user interaction element within the resource of the application. The extracting includes extracting, by the computer processor of the remote electronic device, text associated with the identified user interaction element. The generating includes generating, by the computer processor, of the remote electronic device a voice command corresponding to the extracted text.

In various embodiments, the method further includes transmitting the identified user interaction element to a remote electronic device. The extracting includes extracting, by the computer processor of the remote electronic device, text associated with the identified user interaction element. The generating includes generating, by the computer processor, of the remote electronic device a voice command corresponding to the extracted text.

In various embodiments, the method further includes transmitting the extracted text to a remote electronic device. The generating includes generating, by a computer processor, of the remote electronic device a voice command corresponding to the extracted text.

In various embodiments, an electronic device is configured to execute the method.

An apparatus for enabling speech commands in an application for execution by a computer processor, the apparatus comprising: means for identifying a user interaction element within a resource of the application; means for extracting text associated with the identified user interaction element; means for generating a voice command corresponding to the extracted text; and means for adding the generated voice command to a grammar associated with the application.

In various embodiments, the apparatus further includes means for detecting a speech input from a user; means for comparing the detected speech input to the grammar associated with the application; and means for performing an action if the detected speech input matches the grammar. The action corresponds to a generated voice command of the grammar matching the detected speech input.

In various embodiments, the apparatus further includes means for transmitting the resource of the application a remote electronic device. The means for identifying includes means for identifying, by a computer processor of the remote electronic device, a user interaction element within the resource of the application. The means for extracting includes means for extracting, by the computer processor of the remote electronic device, text associated with the identified user interaction element. The means for generating includes means for generating, by the computer processor, of the remote electronic device a voice command corresponding to the extracted text.

In various embodiments, the apparatus further includes means for transmitting the identified user interaction element to a remote electronic device. The means for extracting includes means for extracting, by the computer processor of the remote electronic device, text associated with the identified user interaction element. The means for generating includes means for generating, by the computer processor, of the remote electronic device a voice command corresponding to the extracted text.

In various embodiments, the apparatus further includes means for transmitting the extracted text to a remote electronic device. The means for generating includes means for generating, by a computer processor, of the remote electronic device a voice command corresponding to the extracted text.

A computer program product for enabling speech commands in an application for execution by a computer processor includes a computer-readable storage medium comprising code for: (i) identifying a user interaction element within a resource of the application; (ii) extracting text associated with the identified user interaction element; (iii) generating a voice command corresponding to the extracted text; and (iv) adding the generated voice command to a grammar associated with the application.

In various embodiments, the code is for: detecting a speech input from a user; comparing the detected speech input to the grammar associated with the application; and performing an action if the detected speech input matches the grammar. The action corresponds to a generated voice command of the grammar matching the detected speech input.

In various embodiments, the code is for transmitting the resource of the application to a remote electronic device. The identifying includes identifying, by a computer processor of the remote electronic device, a user interaction element within the resource of the application. The extracting includes extracting, by the computer processor of the remote electronic device, text associated with the identified user interaction element. The generating includes generating, by the computer processor, of the remote electronic device a voice command corresponding to the extracted text.

In various embodiments, the code is for transmitting the identified user interaction element to a remote electronic device. The extracting includes extracting, by the computer processor of the remote electronic device, text associated with the identified user interaction element. The generating includes generating, by the computer processor, of the remote electronic device a voice command corresponding to the extracted text.

In various embodiments, the code is for transmitting the extracted text to a remote electronic device. The generating includes generating, by a computer processor, of the remote electronic device a voice command corresponding to the extracted text.

An apparatus for enabling speech commands in an application includes a processor configured for, but is not limited to any one or combination of: (i) identifying a user interaction element within a resource of the application; (ii) extracting text associated with the identified user interaction element; (iii) generating a voice command corresponding to the extracted text; and (iv) adding the generated voice command to a grammar associated with the application.

In various embodiments, the processor is further configured for: detecting a speech input from a user; comparing the detected speech input to the grammar associated with the application; and performing an action if the detected speech input matches the grammar. The action corresponds to a generated voice command of the grammar matching the detected speech input.

In various embodiments, the processor is further configured for transmitting the resource of the application a remote electronic device. The identifying includes identifying, by a computer processor of the remote electronic device, a user interaction element within the resource of the application. The extracting includes extracting, by the computer processor of the remote electronic device, text associated with the identified user interaction element. The generating includes generating, by the computer processor, of the remote electronic device a voice command corresponding to the extracted text.

In various embodiments, the processor is further configured for transmitting the identified user interaction element to a remote electronic device. The extracting includes extracting, by the computer processor of the remote electronic device, text associated with the identified user interaction element. The generating includes generating, by the computer processor, of the remote electronic device a voice command corresponding to the extracted text.

In various embodiments, the processor is further configured for transmitting the extracted text to a remote electronic device. The generating includes generating, by a computer processor, of the remote electronic device a voice command corresponding to the extracted text.

### BRIEF DESCRIPTION OF THE DRAWINGS

FIG. 1 illustrates a network environment according to various embodiments of the disclosure.

FIG. 2 illustrates architecture of a client device according to various embodiments of the disclosure.

FIG. 3 illustrates architecture of a host device according to various embodiments of the disclosure.

FIG. 4 illustrates an application for a client device according to various embodiments of the disclosure.

FIG. 5 illustrates an application for a client device according to various embodiments of the disclosure.

FIG. 6 illustrates a flowchart of a method for enabling speech commands in an application for a client device according to various embodiments of the disclosure.

FIG. 7 illustrates a flowchart of a method for enabling speech commands in an application for a client device according to various embodiments of the disclosure.

### DETAILED DESCRIPTION

Various embodiments related to dynamically creating voice command grammar for an application. Various embodiments relate to systems and methods for speech (voice) enabling of a legacy application (i.e., one that was not originally developed for speech recognition) by determining voice commands associated with an application (and its various contexts) by examining the application's resources, which are used to define user interaction elements within the application, and adding voice commands corresponding to text associated with the user interaction elements to a grammar associated with the application. The grammar may be used by a speech recognition system for performing actions based on the added voice commands corresponding to the user interaction elements.

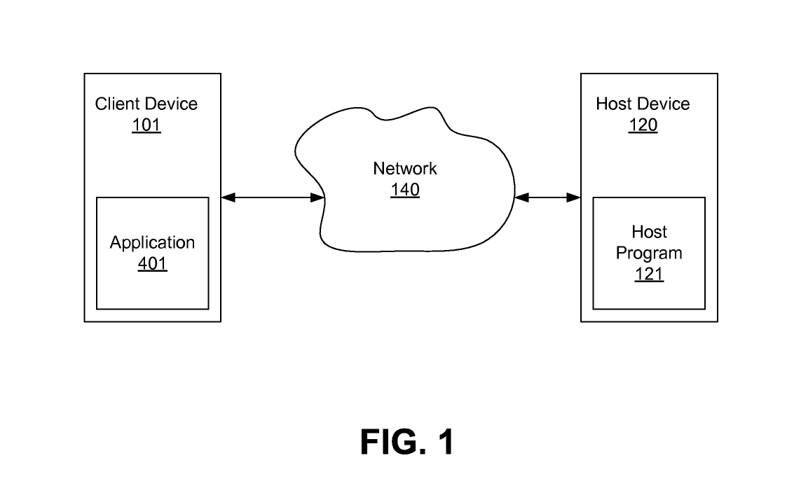

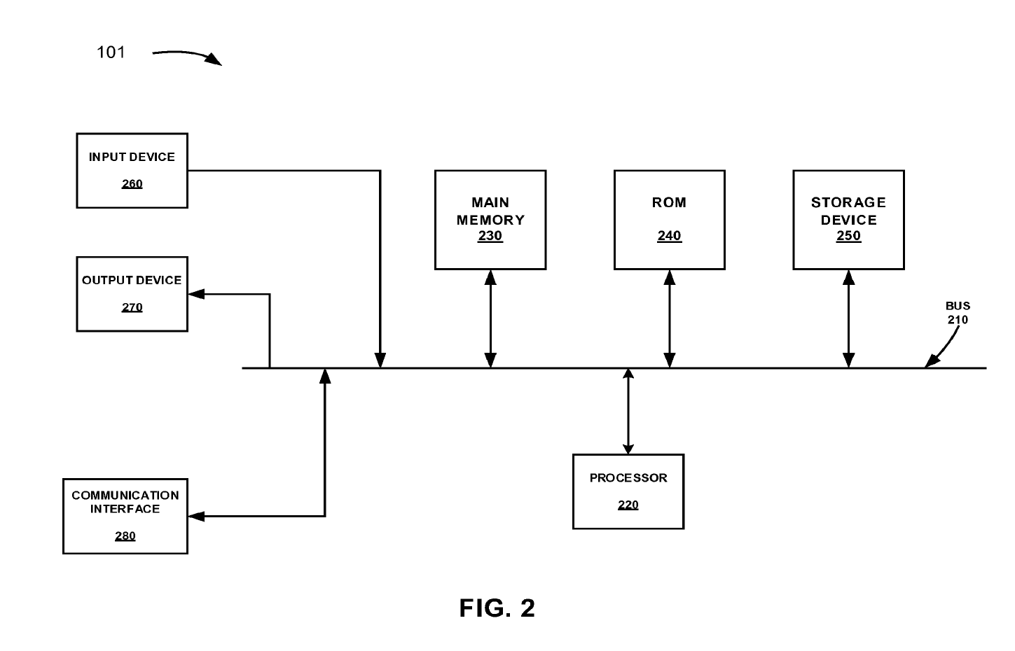

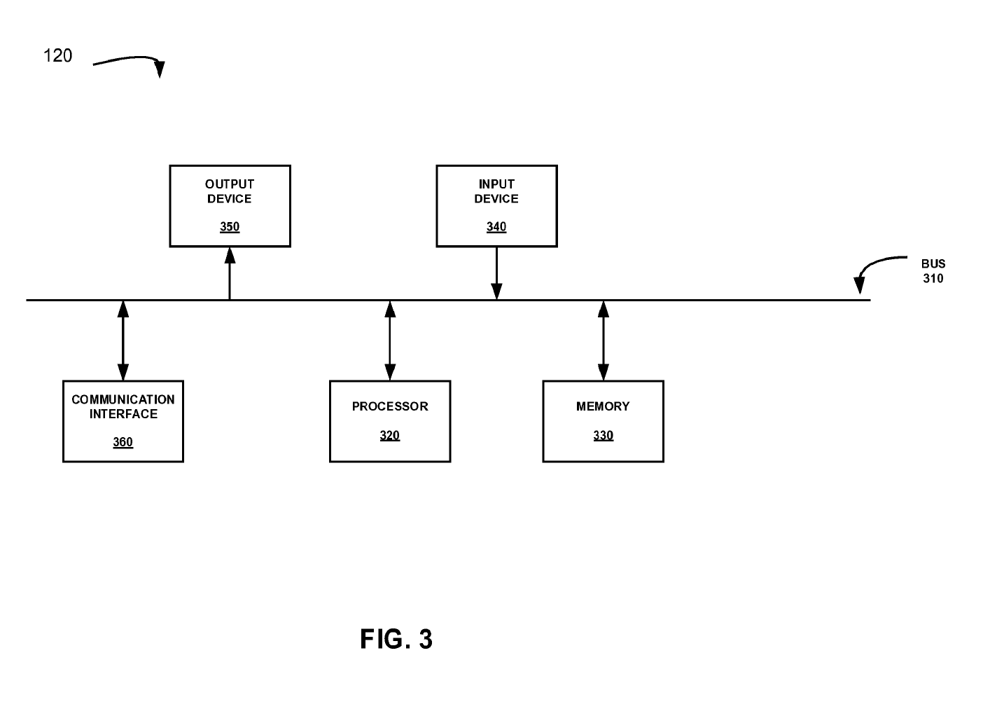

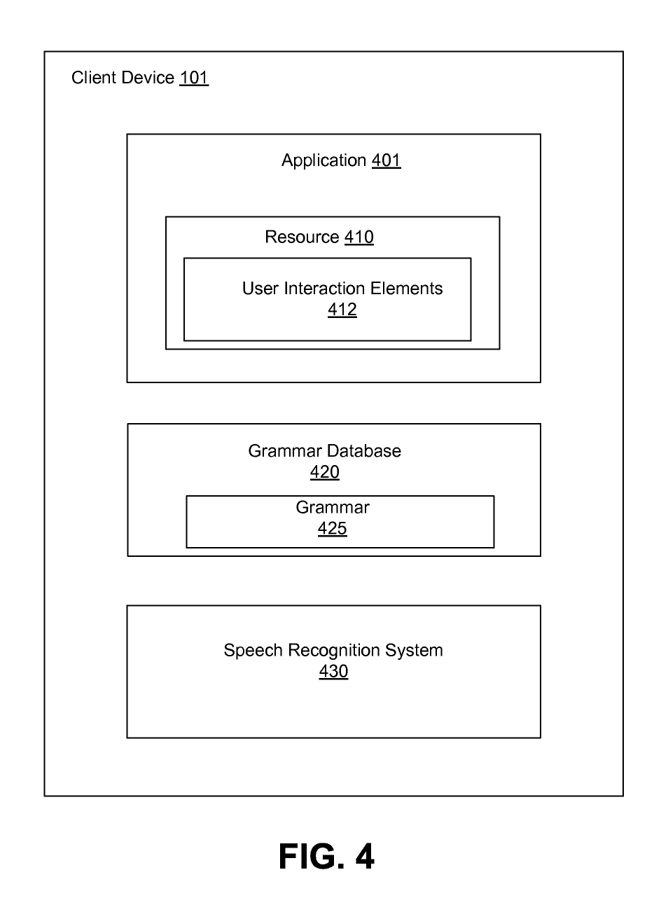

FIG. 1 illustrates an environment 100 according to various embodiments of the disclosure. With reference to FIGS. 1-4, a client device 101 may be connectable to a host device 120 (also referred to as a remote electronic device) via a network 140. The network 140 may be a local area network (LAN), a wide area network (WAN), a telephone network such as the Public Switched Telephone Network (PSTN), an intranet, the Internet, or a combination of networks. In other embodiments, the client device 101 may be connectable directly to the host device 120 (e.g., USB, IR, Bluetooth, etc.). In other embodiments, functionality provided by the host device 120 may be provided on the client device 101. For instance, the client device 101 may include a host program (e.g., host program 121) or application for performing one or functions of the host device 120 as described in the disclosure.

The client device 101 may be, but is not limited to electronic devices, such as cell phones, laptop computers, tablet computers, mainframes, minicomputers, personal computers, laptops, personal digital assistants, telephones, console gaming devices, set-top boxes, or the like.

The client device 101 may include, but is not limited to, a bus 210, a processor 220, a main memory 230, a read only memory (ROM) 240, a storage device 250, an input device 260, an output device 270, a communication interface 280, and/or the like. The bus 210 may include one or more conventional buses that permit communication among the components of the client device 101.

The processor 220 may be any type of conventional processor or microprocessor that interprets and executes instructions. The main memory 230 may be a random access memory (RAM) or another type of dynamic storage device that stores information and instructions for execution by the processor 220. The ROM 240 may be a conventional ROM device or another type of static storage device that stores static information and instructions for use by the processor 220. The storage device 250 may be (but is not limited to) a magnetic, solid-state, and/or optical recording medium and its corresponding drive. The storage device 250 may store one or more programs (e.g., application 401) for execution by the processor 220.

The input device 260 is configured to permit a user to input information to the client device 101, such as (but not limited to) a keyboard, a mouse, a pen, a microphone, voice recognition, biometric system, touch interface, and/or the like. The output device 270 may be configured to output information to the user and may include (but is not limited to) a display, a printer, a speaker, and/or the like. The communication interface 280 allows the client device 101 to communicate with other devices and/or systems, for example the host device 120 via the network 140 or a direct connection (e.g., USB cord).

In some embodiments, the host device 120 is a server or other remote device that may be, but is not limited to, one or more types of computer systems, such as a mainframe, minicomputer, personal computer, and/or the like capable of connecting to the network 140 to enable the server to communicate with the client device 101. In other embodiments, the server may be configured to directly connect with the client device 101.

In various embodiments, the host device 120 includes a host program 121 for enabling speech commands in an application (e.g., 401) for the client device 101. The host program 121 may perform the methods described in the disclosure, for instance, when the host device 120 is operatively connected (e.g., via the network 140 or a direct connection) to the client device 101. In other embodiments, the host program 121 may be loaded onto the client device 101 for performing the methods on the client device 101. For instance, the host program 121 may be a separate application from the application of the client device 101. In yet other embodiments, the application is loaded onto the host device 120 to allow the host program to perform the methods on the application 401 and then the application is loaded onto the client device 101.

The host device 120 may include, but is not limited to, a bus 310, a processor 320, a memory 330, an input device 340, an output device 350, and a communication interface 360. The bus 310 may include one or more conventional buses that allow communication among the components of the host device 120.

The processor 320 may include any type of conventional processor or microprocessor that interprets and executes instructions. The memory 330 may include a RAM or another type of dynamic storage device that stores information and instructions for execution by the processor 320. The memory 330 may include ROM or another type of static storage device that stores static information and instructions for use by the processor 320. The memory 330 may include a storage device 250 that may be (but is not limited to) a magnetic, solid-state, and/or optical recording medium and its corresponding drive. The storage device may store one or more programs for execution by the processor 220. Execution of the sequences of instructions (of the one or more programs) contained in the memory 330 causes the processor 320 to perform the functions described in the disclosure.

The input device 340 is configured to permit a user to input information to the host device 120, such as (but not limited to) a keyboard, a mouse, a pen, a microphone, voice recognition, biometric system, touch interface, and/or the like. The output device 350 may be configured to output information to the user and may include (but is not limited to) a display, a printer, a speaker, and/or the like. The communication interface 360 allows the host device 120 to communicate with other devices and/or systems, for example the client device 101 via the network 140 or a direct connection (e.g., USB cord).

The client device 101 may include one or more applications 401 stored on the storage device 230. The application 401 may be a legacy application that is not enabled for speech recognition. For such applications, the host device 120 may be configured to enable the application 401 for speech recognition. In other embodiments, the application 401 may be an application that is enabled for speech recognition. For such applications, the host device 120 may be configured to add or modify speech recognition ability (e.g., additional speech commands) of the application 401.

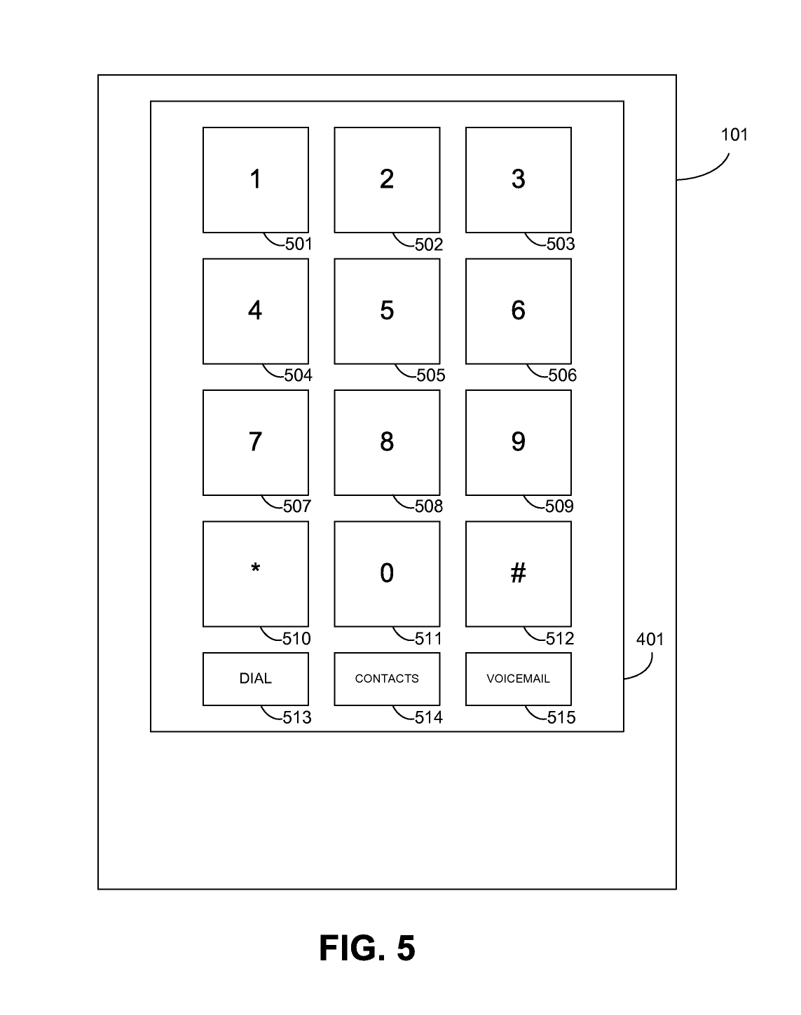

The application 401 may include one or more resources 410 (e.g., layout files, xml files, objects, code, etc.) for carrying out the application 401. The resources 410 may include data relating to user interaction elements 412, such menu items, buttons, list items, keys operators, check boxes, captions, text edit controls, and the like, that allow a user to interact with the application 401 during use of the application. For example, as shown in FIG. 5, a phone application 501 displayed on a touch-screen display of the client device 101 may include user interaction elements 501-515. With reference to FIGS. 1-5, the user interaction elements 412 may correspond to “soft” keys (i.e., a button or operator flexibly programmable to invoke any of a number of functions) (e.g., on a touch-screen display) and/or “hard” keys (i.e., a button or operator associated with a single fixed function or a fixed set of functions) (e.g., volume up/down keys on the client device 101.

In various embodiments, the application 401 may include or be associated with a grammar database 420 containing a grammar 425. A speech recognition system (SRS) 430 may compare the grammar 425 against a detected input from a user. The detected input from the user may be utterances, speech, and/or the like that are converted into a digital signal. Based upon the results of the comparison, the SRS 430 may produce a speech recognition result that represents the detected input. The SRS 430 may be programmed to provide a speech command to the application 401 to perform an action in response to the speech recognition result. For instance, if an entry (speech command) in the grammar 425 matches the detected input from the user, the SRS 430 may identify the corresponding speech command and pass the speech command to the application 401 to perform an action corresponding to the speech command. In some embodiments, the SRS 430 is part of the application 401. In other embodiments, the SRS 430 is associated but separate from the application 401. In some embodiments, the grammar 425 may include one or more files.

The host program 121 may be configured to scan or otherwise examine the resources 410 of the application 401 to identify the user interaction elements 412. In particular embodiments, the host program 121 may be configured to examine specific resources 410 or portions (e.g., relating to menus, operators, etc.) thereof of the application 401 and identify the user interaction elements 412 of the specific resources 410 or portions thereof. For instance, the host program 121 may be configured to identify user interaction elements 412 based on identifiers (e.g., tags) known to be used with user interaction elements. In some embodiments, the resources 410 are examined before the application 401 is run for the first time. In other embodiments, the resources 410 are examined during run time of the application 401. For instance, API calls for iterating through controls of a screen, window, activity, or the like may be examined during run time of the application 401.

The host program 121 may be configured to extract text associated with (e.g., overlaid on) the user interaction elements 412. For example, the host program 121 may extract “Dial,” “Contacts,” and “Voicemail” as the text for the user interaction elements 513, 514, and 515, respectively. The host program 121 may generate voice commands corresponding to the extracted text (e.g., voice commands for “Dial,” “Contacts,” “Voicemail,” etc.) and then add the generated voice commands to the grammar 425. If a grammar does not yet exist, the host program 121 may generate a grammar in the grammar database 420. In some embodiments, the extract text may be transmitted to the host device (e.g., remote server) or other remote device for generating the voice command. The generated voice command may be transmitted back to the client device 101 and adding to the grammar 425. In some embodiments, the generated voice commands may be added to a grammar at the host device 120 and the grammar may be sent to the client device 101 to provide and/or replace a grammar on the client device 101. In some embodiments, the resources 410 of the application 401 may be transmitted to the host device for processing thereon (e.g., to identify user interaction elements 412, extracting text associated with the user interaction elements 412, generating a voice command corresponding to the extracted text, and/or adding the generated voice command to a grammar).

In some embodiments, multiple user interaction elements 412 (and corresponding text) may be combined into a single voice command. For instance, in the phone application, a first voice command for “Call Judy on mobile” may be generated based on the user interaction elements relating to “Call,” a contact “Judy,” and a selectable phone number option “mobile.” Likewise, a second voice command for “Call Judy at home” may be generated based on the user interaction elements relating to “Call,” the contact “Judy,” and a selectable phone number option “home.”

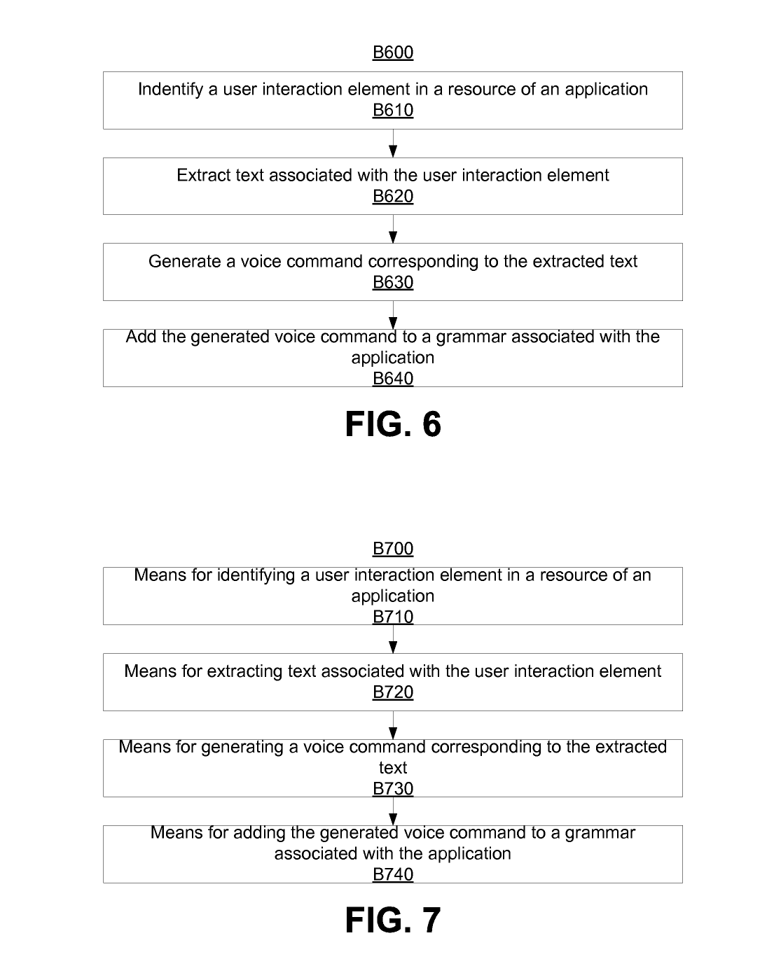

FIG. 6 illustrates a method B600 for enabling speech commands in an application (e.g., application 401, 501 in FIGS. 1-5). FIG. 6 may correspond to FIG. 7. With reference to FIGS. 1-7, at block B610 (B710), the host program 121 examines one or more resources 410 of the application 401 to identify one or more user interaction elements 412. At block B620 (B720), the host program 121 extracts text associated with the user interaction elements 412. At block B630 (B730), the host program 121 generates voice commands corresponding to the extracted text. At block B640 (B740), the host program 121 adds the generated voice commands to the grammar 425 associated with the application 401. Accordingly, a detected input (speech) from a user that matches a generated voice command may cause the SRS 430 to perform an action corresponding to the generated voice command.

For example, for the phone application 501, the host program 121 may examine the resources 410 of the phone application 501 for the user interaction elements 501-515. The host program 121 may then extract text associated with the interaction elements 501-515 (e.g., “1,” “2,” “Dial,” “Contacts,” “Voicemail,” etc.). Then the host program 121 may generate voice commands corresponding to the extracted text and add the generated voice commands to the grammar 425 associated with the phone application 501. Accordingly, when a user speaks speech that matches the text (e.g., user speaks “Dial”) the SRS 430 may perform the corresponding command. For instance, if the user speaks a phone number and then says “Dial,” the SRS 430 will cause the application 501 to input the spoken phone number and then dial the input phone number just as had the user input the phone number and dial command manually using the on-screen buttons (user interaction elements).

In various embodiments, the methods are performed before initial use of the application 401 (e.g., during programming). In other embodiments, the methods may be performed at any time, for example, as an update to the application 401 and/or during use of the application 401.

It should be noted that in various embodiments, any number and/or combination of the processes (e.g., blocks B610-B640) may be performed on a different device (e.g., remote server) than a device (e.g., client device 101) on which other processes are performed.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method of enabling speech commands in an application, comprising:
identifying, by a computer processor, a user interaction element within a resource of the application;
extracting, by the computer processor, text associated with the identified user interaction element;
generating, by the computer processor, a voice command corresponding to the extracted text; and
adding the generated voice command to a grammar associated with the application.

2. The method of claim 1, further comprising:
detecting a speech input from a user;
comparing the detected speech input to the grammar associated with the application; and
performing an action if the detected speech input matches the grammar;
wherein the action corresponds to a generated voice command of the grammar matching the detected speech input.

3. The method of claim 1, wherein the resource of the application comprises one or more of layout files, xml files, and objects for the application.

4. The method of claim 1, wherein the user interaction element comprises at least one of a menu item, button, key, and operator.

5. The method of claim 1, wherein the computer processor is for executing the application.

6. The method of claim 1, wherein the application is stored on a client device for execution thereon by a computer processor of the client device.

7. The method of claim 1, further comprising:
transmitting the resource of the application a remote electronic device;
wherein the identifying comprises: identifying, by a computer processor of the remote electronic device, a user interaction element within the resource of the application;
wherein the extracting comprises: extracting, by the computer processor of the remote electronic device, text associated with the identified user interaction element; and
wherein the generating comprises: generating, by the computer processor, of the remote electronic device a voice command corresponding to the extracted text.

8. The method of claim 1, further comprising:
transmitting the identified user interaction element to a remote electronic device;
wherein the extracting comprises: extracting, by the computer processor of the remote electronic device, text associated with the identified user interaction element; and
wherein the generating comprises: generating, by the computer processor, of the remote electronic device a voice command corresponding to the extracted text.

9. The method of claim 1, further comprising:
transmitting the extracted text to a remote electronic device;
wherein the generating comprises: generating, by a computer processor, of the remote electronic device a voice command corresponding to the extracted text.

10. An electronic device configured to execute the method of claim 1.

11. An apparatus for enabling speech commands in an application for execution by a computer processor, the apparatus comprising:
means for identifying a user interaction element within a resource of the application;
means for extracting text associated with the identified user interaction element;
means for generating a voice command corresponding to the extracted text; and
means for adding the generated voice command to a grammar associated with the application.

12. The apparatus of claim 11, further comprising:
means for detecting a speech input from a user;
means for comparing the detected speech input to the grammar associated with the application; and
means for performing an action if the detected speech input matches the grammar;
wherein the action corresponds to a generated voice command of the grammar matching the detected speech input.

13. The apparatus of claim 11, further comprising:
means for transmitting the resource of the application a remote electronic device;
wherein the means for identifying comprises: means for identifying, by a computer processor of the remote electronic device, a user interaction element within the resource of the application;
wherein the means for extracting comprises: means for extracting, by the computer processor of the remote electronic device, text associated with the identified user interaction element; and
wherein the means for generating comprises: means for generating, by the computer processor, of the remote electronic device a voice command corresponding to the extracted text.

14. The apparatus of claim 11, further comprising:
means for transmitting the identified user interaction element to a remote electronic device;
wherein the means for extracting comprises: means for extracting, by the computer processor of the remote electronic device, text associated with the identified user interaction element; and
wherein the means for generating comprises: means for generating, by the computer processor, of the remote electronic device a voice command corresponding to the extracted text.

15. The apparatus of claim 11, further comprising:
means for transmitting the extracted text to a remote electronic device;
wherein the means for generating comprises: means for generating, by a computer processor, of the remote electronic device a voice command corresponding to the extracted text.

16. A computer program product for enabling speech commands in an application for execution by a computer processor, the computer program product comprising:
a computer-readable storage medium comprising code for:
identifying a user interaction element within a resource of the application;
extracting text associated with the identified user interaction element;
generating a voice command corresponding to the extracted text; and
adding the generated voice command to a grammar associated with the application.

17. The computer program product of claim 16, the code for:
detecting a speech input from a user;
comparing the detected speech input to the grammar associated with the application; and
performing an action if the detected speech input matches the grammar;
wherein the action corresponds to a generated voice command of the grammar matching the detected speech input.

18. The computer program product of claim 16, wherein the computer processor is for executing the application.

19. The computer program product of claim 16, wherein the application is stored on a client device having the computer processor for execution thereon.

20. The computer program product of claim 16, the code for:
transmitting the resource of the application a remote electronic device;
wherein the identifying comprises: identifying, by a computer processor of the remote electronic device, a user interaction element within the resource of the application;
wherein the extracting comprises: extracting, by the computer processor of the remote electronic device, text associated with the identified user interaction element; and
wherein the generating comprises: generating, by the computer processor, of the remote electronic device a voice command corresponding to the extracted text.

21. The computer program product of claim 16, the code for:
transmitting the identified user interaction element to a remote electronic device;
wherein the extracting comprises: extracting, by the computer processor of the remote electronic device, text associated with the identified user interaction element; and
wherein the generating comprises: generating, by the computer processor, of the remote electronic device a voice command corresponding to the extracted text.

22. The computer program product of claim 16, the code for:
transmitting the extracted text to a remote electronic device;
wherein the generating comprises: generating, by a computer processor, of the remote electronic device a voice command corresponding to the extracted text.

23. An apparatus for enabling speech commands in an application, the apparatus comprising:
a processor configured for:
identifying a user interaction element within a resource of the application;
extracting text associated with the identified user interaction element;
generating a voice command corresponding to the extracted text; and
adding the generated voice command to a grammar associated with the application.

24. The apparatus of claim 23, the processor further configured for:
detecting a speech input from a user;
comparing the detected speech input to the grammar associated with the application;
performing an action if the detected speech input matches the grammar;
wherein the action corresponds to a generated voice command of the grammar matching the detected speech input.

25. The apparatus of claim 23, the processor further configured for:
transmitting the resource of the application a remote electronic device;
wherein the identifying comprises: identifying, by a computer processor of the remote electronic device, a user interaction element within the resource of the application;
wherein the extracting comprises: extracting, by the computer processor of the remote electronic device, text associated with the identified user interaction element; and
wherein the generating comprises: generating, by the computer processor, of the remote electronic device a voice command corresponding to the extracted text.

26. The apparatus of claim 23, the processor further configured for:
transmitting the identified user interaction element to a remote electronic device;
wherein the extracting comprises: extracting, by the computer processor of the remote electronic device, text associated with the identified user interaction element; and
wherein the generating comprises: generating, by the computer processor, of the remote electronic device a voice command corresponding to the extracted text.

27. The apparatus of claim 23, the processor further configured for:
transmitting the extracted text to a remote electronic device;
wherein the generating comprises: generating, by a computer processor, of the remote electronic device a voice command corresponding to the extracted text.
